(19) United States
(12) Patent Application Publication
(10) Pub. No.: US 2025/0293373 A1
(43) Pub. Date: Sep. 18, 2025

(54) BATTERY ASSEMBLY

(71) Applicants: HYUNDAI MOTOR COMPANY, Seoul (KR); Kia Corporation, Seoul (KR)

(72) Inventors: Hyun Chang KANG, Hwaseong-si (KR); In Gook SON, Hwaseong-si (KR); Ju Hee KIM, Hwaseong-si (KR); Ji Woong JUNG, Hwaseong-si (KR); Jun Young KANG, Hwaseong-si (KR)

(73) Assignees: HYUNDAI MOTOR COMPANY, Seoul (KR); Kia Corporation, Seoul (KR)

(21) Appl. No.: 18/952,862

(22) Filed: Nov. 19, 2024

(30) Foreign Application Priority Data
Mar. 15, 2024 (KR) 10-2024-0036654

(51) Int. Cl. H01M 50/258; H01M 50/209; H01M 50/474

(52) U.S. Cl. CPC H01M 50/258; H01M 50/209; H01M 50/474

(57) ABSTRACT

Disclosed is a battery assembly including a battery group including a plurality of batteries arranged in a first direction D1 intersecting an upward/downward direction H, and a cover part provided at one side of the battery group based on the upward/downward direction H, in which the cover part includes a partition wall region extending in the upward/downward direction H toward the battery group, and in which the partition wall region is provided in a region between the two adjacent batteries in the battery group based on the first direction D1.

### CROSS-REFERENCE TO RELATED APPLICATION

This application claims priority to and the benefit of Korean Patent Application No. 10-2024-0036654 filed in the Korean Intellectual Property Office on Mar. 15, 2024, the entire contents of which are incorporated herein by reference.

### TECHNICAL FIELD

The present disclosure relates to a battery assembly, and more particularly, to a battery assembly capable of being applied to a battery module or a battery pack.

### BACKGROUND ART

As the demand for electric vehicles continues to grow, there is also an increasing demand for batteries mounted in the electric vehicles. The types of batteries may be variously classified depending on materials of positive and negative electrodes that constitute the batteries. Among the batteries, lithium-ion batteries are widely used because the lithium-ion batteries are lightweight and have high energy efficiency per unit volume. However, the lithium-ion battery has a drawback in that high reactivity of lithium causes a high risk of fire and explosion.

In order to solve the problem with the lithium-ion battery, a safety device for preparing for a fire or explosion of the battery is required to be provided in a battery module or battery pack equipped with the lithium-ion battery.

For example, in instances where thermal runaway occurs in one or more of a plurality of batteries mounted in the battery module or battery pack, thermal energy or gas, which is caused by the thermal runaway, may be introduced into other adjacent batteries, which may cause thermal runaway even in the other batteries due to a chain effect.

However, in conventional systems, there is a problem in that the battery module or battery pack is not equipped with suitable means for suppressing the chain effect of thermal runaway in case that the thermal runaway occurs in some of the batteries.

### SUMMARY

The present disclosure has been made in an effort to improve the safety of a battery module and battery pack by preventing thermal runaway, which occurs in some batteries in the battery module or battery pack, from propagating to other batteries.

In order to achieve the above-mentioned object, one aspect of the present disclosure provides a battery assembly including: a battery group including a plurality of batteries arranged in a first direction D1 intersecting an upward/downward direction H; and a cover part provided at one side of the battery group based on the upward/downward direction H, in which the cover part includes a partition wall region extending in the upward/downward direction H toward the battery group, and in which the partition wall region is provided in a region between the two adjacent batteries in the battery group based on the first direction D1.

The partition wall region may at least partially overlap, in the upward/downward direction H, the two batteries provided adjacent to two opposite sides of the partition wall region based on the first direction D1 among the batteries in the battery group.

The cover part may further include a cover body configured to define a body of the cover part, the partition wall region may extend in the upward/downward direction H toward the battery group from the cover body, and the partition wall region may be integrated with the cover body.

The cover part may further include a cover body configured to define a body of the cover part, the partition wall region may extend in the upward/downward direction H toward the battery group from the cover body, the partition wall region and the cover body may be provided as separate components, and the partition wall region may include: a coupling section fixedly coupled to the cover body; and an extension section extending toward the battery group from the coupling section.

The extension section may extend toward the battery group from one end of the coupling section based on the first direction D1.

The extension section may extend toward the battery group from a region spaced apart from two opposite ends of the coupling section based on the first direction D1.

The extension section may include: a first extension section extending toward the battery group from one side of the coupling section; and a second extension section extending toward the battery group from the other side of the coupling section and provided to be spaced apart from the first extension section.

The partition wall region may have a shape recessed in the upward/downward direction H toward the battery group from the cover body.

The battery assembly may further include: endplates provided at two opposite sides of the battery group based on the first direction D1; and front and rear covers provided at two opposite sides of the battery group based on a second direction D2 intersecting the first direction D1 and the upward/downward direction H, in which the cover part is fixedly coupled to the endplates or the front and rear covers.

The cover part may be fixedly coupled to the endplates or the front and rear covers by i) welding, ii) bolting, or iii) snap-fit coupling.

The cover part may further include a cover body configured to define a body of the cover part, the partition wall region may extend in the upward/downward direction H toward the battery group from the cover body, and the cover body may include: a first cover section provided to face the battery group in the upward/downward direction H and having one side from which the partition wall region extends; and second cover sections extending in the upward/downward direction H from two opposite sides of the first cover section based on the first direction D1 and tightly attached to the battery group to press the battery group in the first direction D1.

The battery assembly may further include: a clamp member having one end and the other end fixed to the second cover sections provided at the two opposite sides of the first cover section, the clamp member having an extension section configured to connect one end and the other end and spaced apart from the first cover section in the upward/downward direction H.

The cover part may further include a cover body configured to define a body of the cover part, the cover part may include: a first cover part provided to face the battery group in the upward/downward direction H and having one side from which the partition wall region extends; and a second cover part having the cover body, and the first cover part may further include an extension region extending in the first direction D1 from one end of the partition wall region and provided to face the cover body with the partition wall region interposed therebetween.

The partition wall region may have a shape bent in the upward/downward direction H from one end of the extension region based on the first direction D1.

The battery assembly may further include: a clamp member having one end and the other end respectively fixed to two opposite sides of the battery group based on the first direction D1, the clamp member having an extension section configured to connect one end and the other end and provided to traverse an upper or lower surface of the battery group, in which the cover part is fixedly coupled to a region of the clamp member that traverses the upper or lower surface of the battery group.

The cover part may further include a clamp coupling region extending in the first direction D1 from the partition wall region, and the clamp coupling region may be fixedly coupled to the clamp member.

The cover part may further include a cover body configured to define a body of the cover part, the partition wall region may extend in the upward/downward direction H toward the battery group from the cover body, and the clamp coupling region may be provided between the cover body and the battery group in the upward/downward direction H.

The partition wall region may extend in a second direction D2 intersecting the first direction D1 and the upward/downward direction H, the clamp coupling region may be provided as a plurality of clamp coupling regions, and the plurality of clamp coupling regions may be provided to be spaced apart from one another in the second direction D2.

The partition wall region may further include a plurality of cut-out sections spaced apart from one another in the second direction D2 and each having a shape recessed inward from one side end based on the upward/downward direction H, and the clamp coupling region may include a shape bent in the first direction D1 from the other side end of the cut-out section based on the upward/downward direction H.

At least a part of the partition wall region may be tightly attached to a lateral surface of the battery provided adjacent to the partition wall region in the first direction D1 among the batteries in the battery group.

The cover body may be provided to overlap an entire region of the clamp coupling region when the battery assembly is viewed from one side spaced apart from the battery assembly in the upward/downward direction H.

The battery assembly may further include: a casing body part having a space for accommodating the battery group and opened at one side based on the upward/downward direction H, the cover part may be provided to cover an opened region of the casing body part, the casing body part may include a plurality of division regions spaced apart from one another in the first direction D1 and configured to define therein a space for accommodating the battery group, and two opposite ends of the cover part based on the first direction D1 may be respectively fixedly coupled to different division regions.

The battery assembly may further include: a covering part provided to face the battery group with the cover part interposed therebetween and configured to cover the cover part.

The battery assembly may further include: a casing body part having a space for accommodating the battery group and opened at one side based on the upward/downward direction H, in which the cover part is provided to cover an opened region of the casing body part, and in which the battery group includes a first battery group and a second battery group provided to face each other in a second direction D2 intersecting the first direction D1 and the upward/downward direction H.

The partition wall region may be provided as a plurality of partition wall regions, and some of the plurality of partition wall regions may be provided between the two battery groups adjacent to each other in the first direction D1.

The casing body part may include a plurality of division regions spaced apart from one another in the first direction D1 and configured to define therein a space for accommodating the battery group, and some of the plurality of partition wall regions may be provided between the division region and the battery group provided adjacent to the division region.

Some of the plurality of partition wall regions may be respectively provided i) between the division region and the battery group provided adjacent to the division region at one side based on the first direction D1 and ii) between the division region and the battery group provided adjacent to the division region at the other side based on the first direction D1.

The partition wall regions may include: a first partition wall region provided to face the first battery group in the upward/downward direction H; and a second partition wall region spaced apart from the first partition wall region in the second direction D2 and provided to face the second battery group in the upward/downward direction H.

The partition wall region may include a single member provided to face, in the upward/downward direction H, i) the first battery group, ii) the second battery group, and iii) a space between the first battery group and the second battery group.

The battery group may further include a pad member provided between the two batteries adjacent to each other in the first direction D1 in the battery group and tightly attached to the two batteries, and the partition wall region may be relatively fixedly coupled to the pad member.

The battery assembly may further include: a contact member provided between the partition wall region and the pad member, in which one region of the contact member is joined to the partition wall region, and the other region of the contact member is joined to the pad member.

The pad member may include: an extension pad extending in the upward/downward direction H and having at least a partial region provided between the two batteries adjacent to each other in the first direction D1 in the battery group; and branch pads branching off from an end of the extension pad based on the upward/downward direction H toward two opposite sides, and the contact member may be joined to one side of each of the branch pads branching toward the two opposite sides.

A region of the contact member, which faces a region in which the branch pads branch off from the extension pad, may be joined to the partition wall region.

The battery assembly may further include: a fixing member having one side being in contact with the partition wall region, and the other side being in contact with the pad member, in which the fixing member includes: a first insertion region extending from a region being in contact with the partition wall region and configured to be inserted into the partition wall region; and a second insertion region extending from a region being in contact with the pad member and configured to be inserted into the pad member.

According to the present disclosure, it is possible to improve the safety of the battery module and battery pack by preventing thermal runaway, which occurs in some of the batteries in the battery module or battery pack, from propagating to other batteries.

### BRIEF DESCRIPTION OF THE DRAWINGS

FIG. 1 is a perspective view illustrating a first example of a battery assembly according to the present disclosure.

FIG. 2 is a cross-sectional view taken along line a-a in FIG. 1.

FIG. 3 is a cross-sectional view taken along line b-b in FIG. 1.

FIG. 4 is a cross-sectional view illustrating a first modified example of a partition wall region capable of being applied to the battery assembly according to the present disclosure.

FIG. 5 is a cross-sectional view illustrating a second modified example of the partition wall region capable of being applied to the battery assembly according to the present disclosure.

FIG. 6 is a cross-sectional view illustrating a third modified example of the partition wall region capable of being applied to the battery assembly according to the present disclosure.

FIG. 7 is a cross-sectional view illustrating a fourth modified example of the partition wall region capable of being applied to the battery assembly according to the present disclosure.

FIG. 8 is a cross-sectional view illustrating a fifth modified example of the partition wall region capable of being applied to the battery assembly according to the present disclosure.

FIG. 9 is a perspective view illustrating a second example of the battery assembly according to the present disclosure, i.e., an exploded perspective view illustrating a state in which a cover part is spaced apart from another component of the battery assembly.

FIG. 10 is a cross-sectional view illustrating an example of a structure for coupling the cover part and an endplate or coupling the cover part and a front or rear cover illustrated in FIG. 9.

FIG. 11 is a cross-sectional view illustrating another example of the structure for coupling the cover part and the endplate or coupling the cover part and the front or rear cover illustrated in FIG. 9.

FIG. 12 is a perspective view illustrating a third example of the battery assembly according to the present disclosure, i.e., an exploded perspective view illustrating a state in which a cover part is spaced apart from another component of the battery assembly.

FIG. 13 is a perspective view illustrating a state in which the cover part of the battery assembly in FIG. 12 is coupled to another component of the battery assembly.

FIG. 14 is a perspective view illustrating a cover part of a fourth example of the battery assembly according to the present disclosure.

FIG. 15 is a perspective view illustrating a fourth example of the battery assembly according to the present disclosure, i.e., an exploded perspective view illustrating a state in which a cover part is spaced apart from another component of the battery assembly.

FIG. 16 is a perspective view illustrating a state in which the cover part of the battery assembly in FIG. 15 is coupled to another component of the battery assembly.

FIG. 17 is a vertical cross-sectional view of FIG. 16.

FIG. 18 is a perspective view illustrating a fifth example of the battery assembly according to the present disclosure, i.e., an exploded perspective view illustrating a state in which a cover part is spaced apart from another component of the battery assembly.

FIG. 19 is a perspective view illustrating a state in which the cover part of the battery assembly in FIG. 18 is coupled to another component of the battery assembly.

FIG. 20 is a perspective view of the cover part applied to the battery assembly in FIGS. 18 and 19.

FIG. 21 is a perspective view of a modified example of the cover part applied to the battery assembly in FIGS. 18 and 19.

FIG. 22 is a perspective view illustrating a sixth example of the battery assembly according to the present disclosure, i.e., a view illustrating a structure for coupling a casing body part and a cover part of the battery assembly.

FIG. 23 is a vertical cross-sectional view of the sixth example of the battery assembly according to the present disclosure.

FIG. 24 is a vertical cross-sectional view illustrating a seventh example of the battery assembly according to the present disclosure.

FIG. 25 is an example of a top plan view of the battery assembly in FIG. 24.

FIG. 26 is another example of a top plan view of the battery assembly in FIG. 24.

FIG. 27 is a vertical cross-sectional view illustrating a first example of a coupling relationship between the partition wall region and a pad member of the battery assembly according to the present disclosure.

FIG. 28 is a vertical cross-sectional view illustrating a second example of the coupling relationship between the partition wall region and the pad member of the battery assembly according to the present disclosure.

FIG. 29 is a vertical cross-sectional view illustrating a change in shapes of the partition wall region and the pad member in case that an internal pressure of a battery of the battery assembly in FIG. 28 increases.

FIG. 30 is a perspective view illustrating a third example of the coupling relationship between the partition wall region and the pad member of the battery assembly according to the present disclosure.

### DETAILED DESCRIPTION

Hereinafter, a battery assembly according to the present disclosure will be described with reference to the drawings.

### Battery Assembly

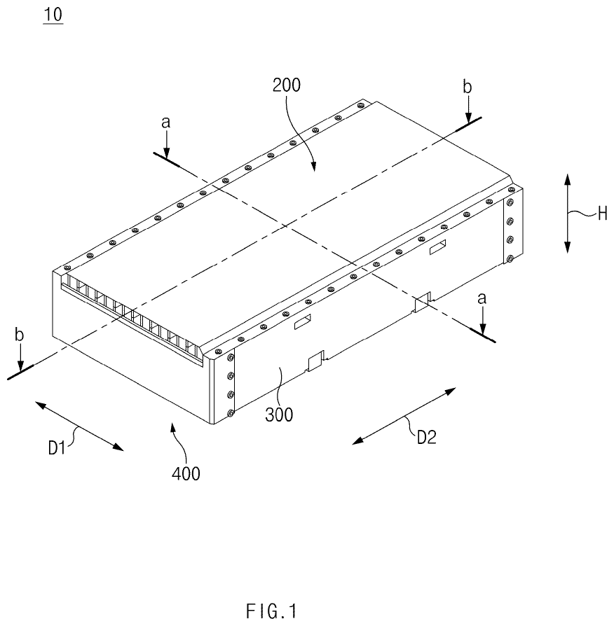

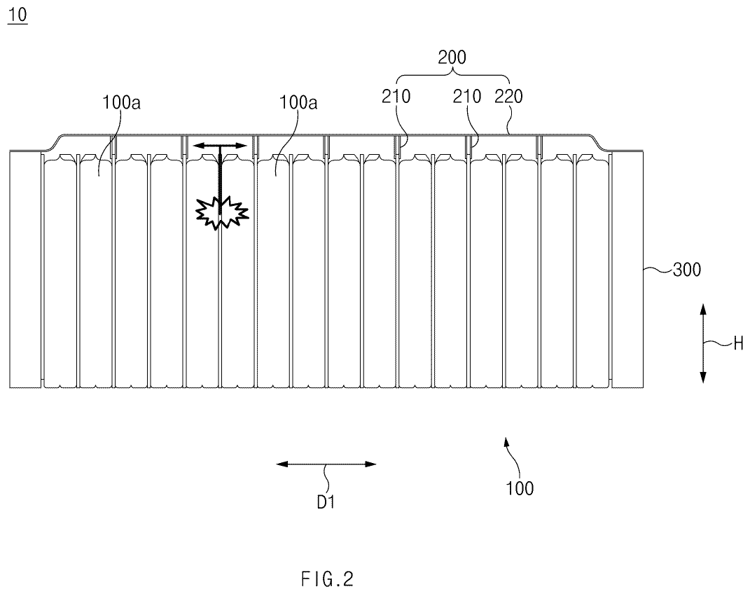

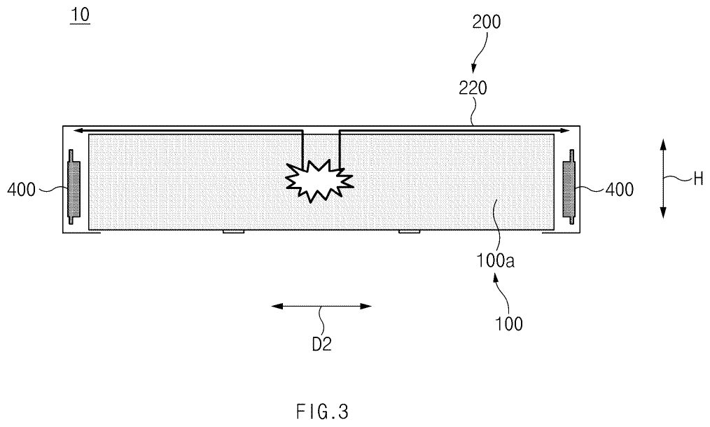

FIG. 1 is a perspective view illustrating a first example of a battery assembly according to the present disclosure. FIG. 2 is a cross-sectional view taken along line a-a in FIG. 1, and FIG. 3 is a cross-sectional view taken along line b-b in FIG. 1.

A battery assembly 10 according to the present disclosure may include a battery group 100 including a plurality of batteries 100a arranged in a first direction D1 intersecting an upward/downward direction H, and a cover part 200 provided at one side of the battery group 100 based on the upward/downward direction H. For example, the cover part 200 may be provided in a lower region of the battery group 100. However, as illustrated in FIGS. 1 to 3, the cover part 200 may be provided in an upper region of the battery group 100. Hereinafter, for convenience of description, with reference to the drawings in the present specification, the description will be focused on a case in which the cover part 200 is provided in the upper region of the battery group 100.

According to the present disclosure, the cover part 200 may include partition wall regions 210 extending in the upward/downward direction H toward the battery group 100. In some embodiments, the cover part 200 is provided in the upper region of the battery group 100 and the partition wall region 210 may have a shape extending downward toward the battery group 100.

In case that thermal runaway occurs in some of the batteries in the battery group 100, the partition wall region 210 may be configured to prevent a situation in which flame or high-temperature materials, which are caused by the thermal runaway, propagate to other batteries in the battery group 100 and the thermal runaway is diffused (see FIG. 2). Furthermore, in case that thermal runaway occurs in some of the batteries in the battery group 100, the partition wall region 210 may be configured to guide gas, which is caused by the thermal runaway, so that the gas is discharged to the outside through a predetermined route (see FIG. 3).

In order to achieve the above-mentioned object, according to embodiments the present disclosure, the partition wall region 210 may be provided in a region between two adjacent batteries 100a of the battery group 100 based on the first direction D1. In this case, the configuration in which the partition wall region 210 is provided in the region between two adjacent batteries 100a based on the first direction D1 does not mean only a case in which the partition wall region 210 is provided to partially overlap the two adjacent batteries 100a in the upward/downward direction H. That is, the configuration in which the partition wall region 210 is provided in the region between the two adjacent batteries 100a based on the first direction D1 may be interpreted as including a case in which the partition wall region 210 is positioned between the two adjacent batteries 100a when the battery assembly 10 is viewed from one side based on the upward/downward direction H even though the partition wall region 210 is spaced apart from the two adjacent batteries 100a in the upward/downward direction H.

In some embodiments, and as illustrated in FIG. 2, the partition wall region 210 may be provided to at least partially overlap, in the upward/downward direction H, the two batteries 100a provided adjacent to two opposite sides of the partition wall region 210 based on the first direction D1 among the batteries 100a in the battery group 100. In such embodiments, in case that thermal runaway occurs in some of the batteries 100a in the battery group 100, the partition wall region 210 may more effectively prevent the thermal runaway from diffusing.

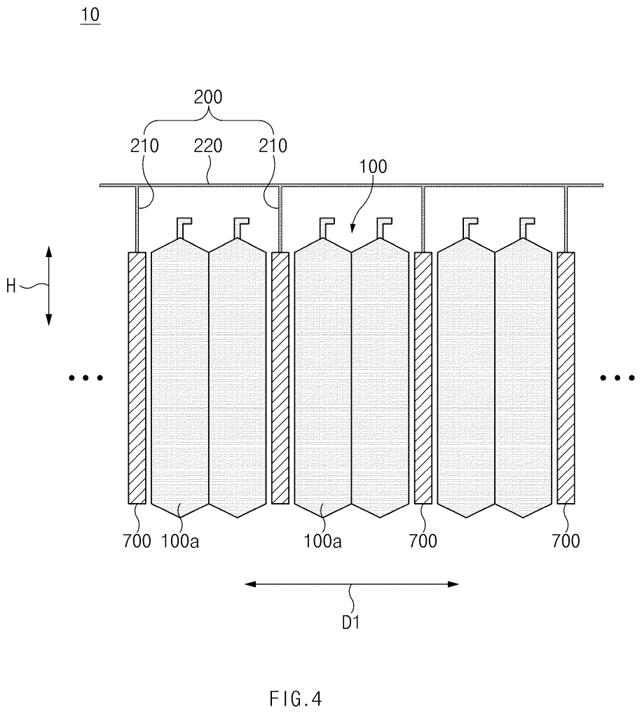

FIG. 4 is a cross-sectional view illustrating a first modified example of the partition wall region capable of being applied to the battery assembly according to the present disclosure.

Meanwhile, with continued reference to FIGS. 1 to 4, the cover part 200 of the battery assembly 10 may further include a cover body 220 configured to define a body of the cover part 200. For example, the cover body 220 may have a shape extending in the first direction D1. In this case, as illustrated in FIG. 4, the partition wall region 210 may extend in the upward/downward direction H toward the battery group 100 from the cover body 220, and the partition wall region 210 may be integrated with the cover body 220. The configuration in which two or more components are integrated may mean a state in which the two or more components are indivisibly coupled to each other to the extent that the two or more components cannot be separated without irreversibly destroying at least one of the two or more components. In some embodiments, the two or more components may be joined to each other by a material with bondability and the two or more components may be separated from each other without being damaged by removing the material. Such embodiments may not be considered as a configuration in which the two or more components are integrated.

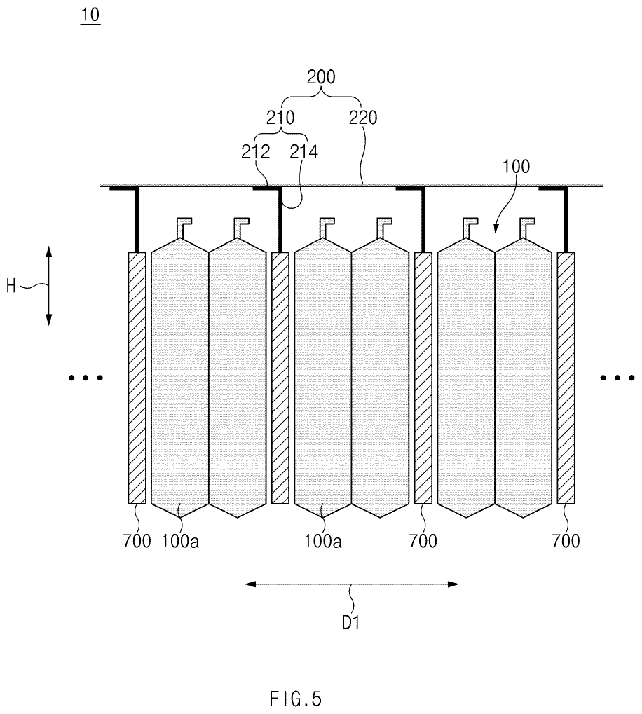

In some embodiments, the partition wall region 210 and the cover body 220 may be provided as separate components. Hereinafter, various features of embodiments of a cover part 200 in which the partition wall region 210 and the cover body 220 are provided as separate components will be described with reference to FIGS. 5 to 8.

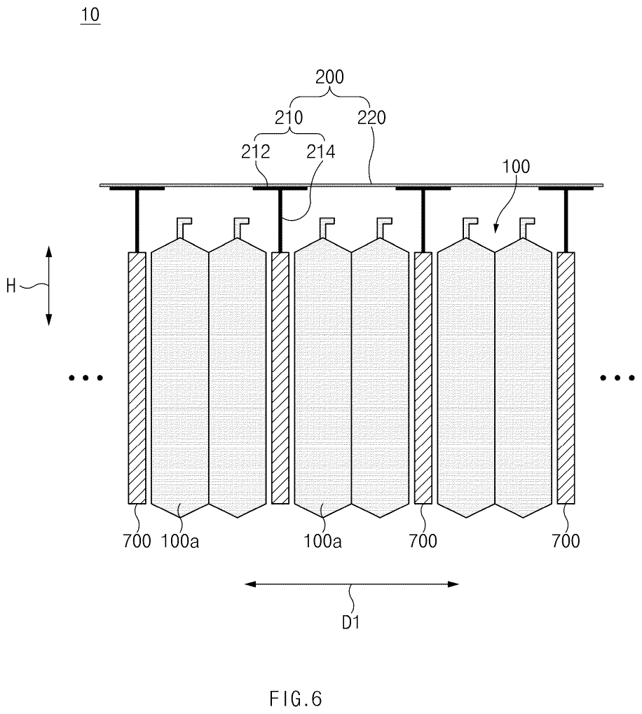

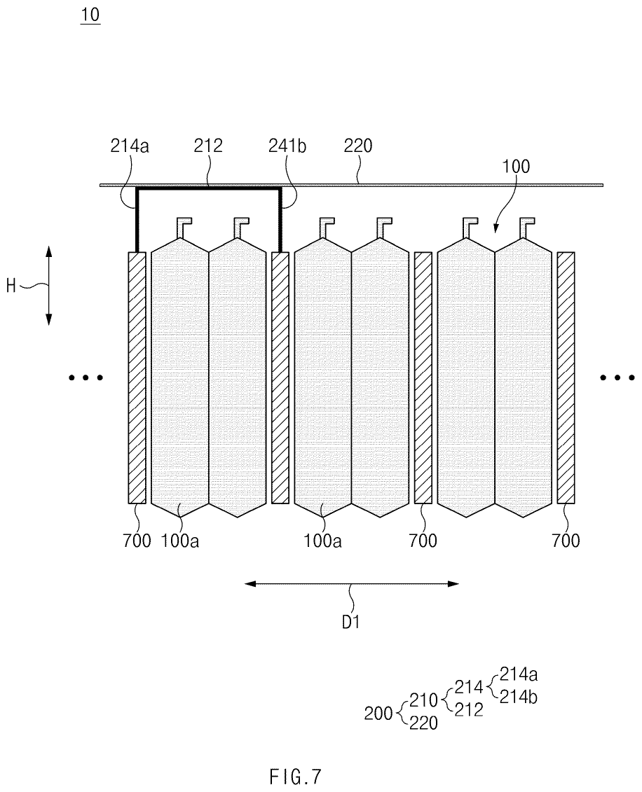

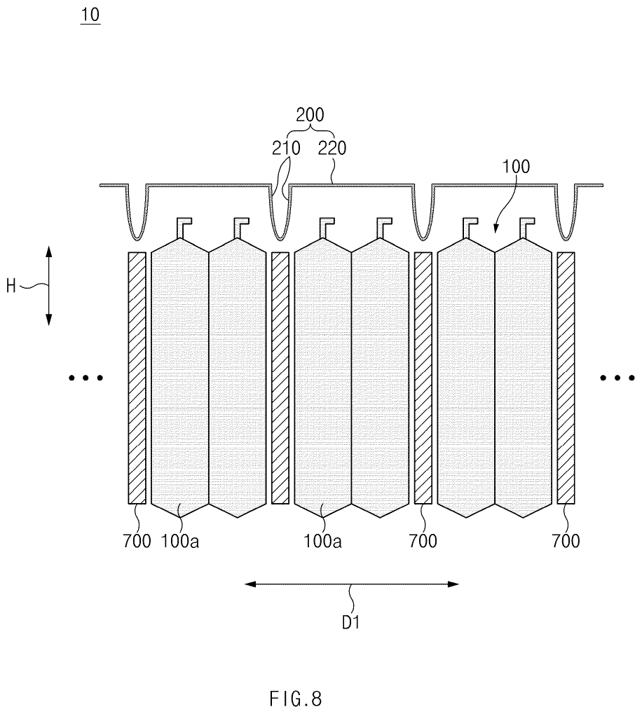

FIG. 5 is a cross-sectional view illustrating a second modified example of the partition wall region capable of being applied to the battery assembly according to the present disclosure, and FIG. 6 is a cross-sectional view illustrating a third modified example of the partition wall region capable of being applied to the battery assembly according to the present disclosure. FIG. 7 is a cross-sectional view illustrating a fourth modified example of the partition wall region capable of being applied to the battery assembly according to the present disclosure, and FIG. 8 is a cross-sectional view illustrating a fifth modified example of the partition wall region capable of being applied to the battery assembly according to the present disclosure.

As described above, the cover part 200 may further include the cover body 220, and the partition wall region 210 may extend in the upward/downward direction H toward the battery group 100 from the cover body 220.

In some embodiments, and with reference to FIGS. 5 and 6, the partition wall region 210 and the cover body 220 are provided as separate components and the partition wall region 210 may include a coupling section 212 having an upper or lower surface fixedly coupled to the cover body 220, and an extension section 214 extending in the upward/downward direction H toward the battery group 100 from the coupling section 212. FIG. 5 illustrates an example in which the extension section 214 has a shape extending in the upward/downward direction H toward the battery group 100 from one end of the coupling section 212 based on the first direction D1. It may be understood that a cross-section made by cutting the partition wall region 210 in parallel with the first direction D1 and the upward/downward direction H has an approximate ‘L’ shape.

In some embodiments, and as illustrated in FIG. 6, the extension section 214 may extend in the upward/downward direction H toward the battery group 100 from a region spaced apart, in the first direction D1, from two opposite ends of the coupling section 212 based on the first direction D1. It may be understood that a cross-section made by cutting the partition wall region 210 in parallel with the first direction D1 and the upward/downward direction H has an approximate ‘T’ shape. FIG. 5 illustrates that a cross-sectional shape of the partition wall region 210 is a ‘T’ shape having a symmetric structure.

In some embodiments, and as illustrated in FIG. 7, the extension section 214 may be provided as a plurality of extension sections 214 extending from one coupling section 212. That is, unlike FIGS. 5 and 6 illustrating that one extension section 214 extends from one coupling section 212, the extension sections 214, as illustrated in FIG. 7, may include a first extension section 214a extending toward the battery group 100 from one side of the coupling section 212 based on the first direction D1, and a second extension section 214b extending toward the battery group 100 from the other side of the coupling section 212 based on the first direction D1. For example, the first extension section 214a and the second extension section 214b may extend from two opposite ends of the coupling section 212 based on the first direction D1.

In some embodiments, and as illustrated in FIG. 8, the partition wall region 210 may be formed as a partial region of the cover body 220 is recessed toward the battery group 100. More specifically, the partition wall region 210 may have a shape recessed in the upward/downward direction H toward the battery group 100 from the cover body 220.

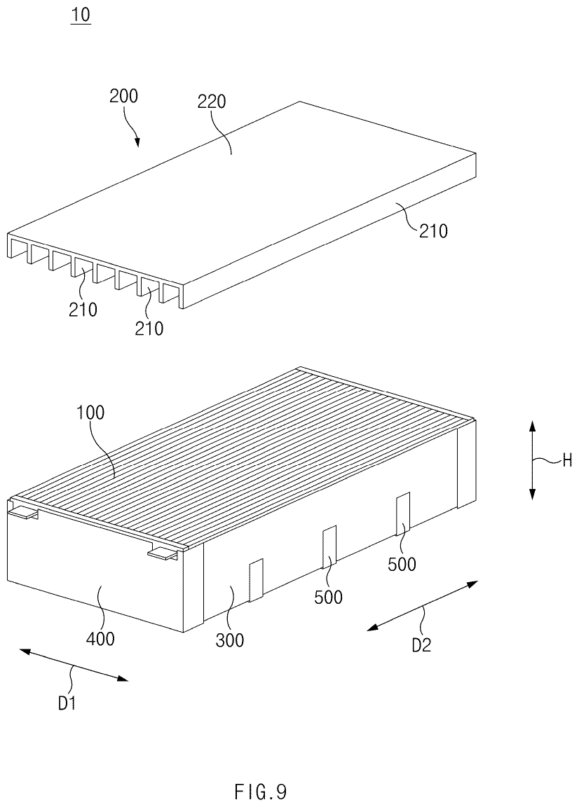

Various examples of the cover part 200 capable of being applied to the battery assembly of the present disclosure will be described with reference to FIGS. 9 to 26.

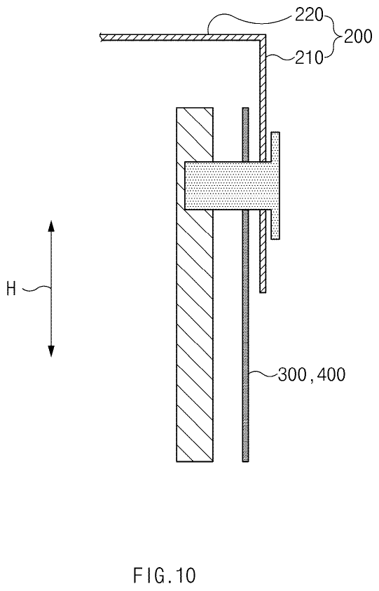

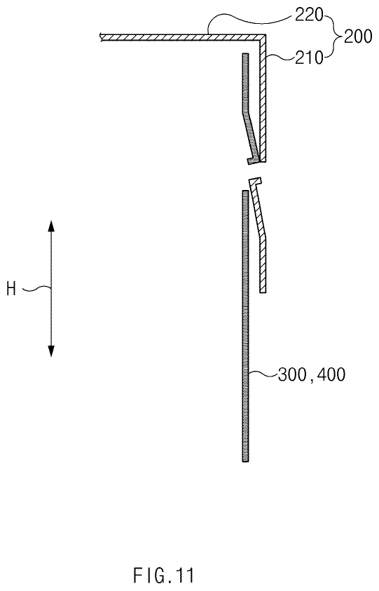

FIG. 9 is a perspective view illustrating a second example of the battery assembly according to the present disclosure, i.e., an exploded perspective view illustrating a state in which a cover part is spaced apart from another component of the battery assembly, and FIG. 10 is a cross-sectional view illustrating an example of a structure for coupling the cover part and an endplate or coupling the cover part and a front or rear cover illustrated in FIG. 9. FIG. 11 is a cross-sectional view illustrating another example of the structure for coupling the cover part and the endplate or coupling the cover part and the front or rear cover illustrated in FIG. 9.

With reference to FIGS. 9 to 11, the battery assembly 10 according to the present disclosure may be a battery module including a plurality of batteries. The battery module may further include a configuration for applying a predetermined surface pressure to the batteries.

That is, with reference to FIG. 9, the battery assembly 10 according to the present disclosure may further include endplates 300 provided at two opposite sides of the battery group 100 based on the first direction D1. The endplates 300 may be configured to apply a predetermined surface pressure to the batteries by pressing against the batteries 100a (see FIGS. 2 and 3 and the like) in the battery group in the first direction D1.

The battery assembly 10 may further include front and rear covers 400 provided at two opposite sides of the battery group 100 based on a second direction D2 intersecting the first direction D1 and the upward/downward direction H. The second direction D2 may perpendicularly intersect the first direction D1. For example, in case that the first direction D1 is a leftward/rightward direction, the second direction D2 may be a forward/rearward direction. The front and rear covers 400 may serve to protect a sensing block, which is provided in the battery module and configured to sense voltages of the batteries in the battery module, from the outside.

In some embodiments, and with reference to FIGS. 9 to 11, the cover part 200 may be fixedly coupled to the endplates 300 and/or the front and rear covers 400. For example, the cover part 200 may be fixedly coupled to the endplates 300 or the front and rear covers 400 by i) welding, ii) bolting, or iii) snap-fit coupling. FIG. 10 illustrates that the cover part 200 is fixedly coupled to the endplate 300 or the front or rear cover 400 by bolting, and FIG. 11 illustrates that the cover part 200 is fixedly coupled to the endplate 300 or the front or rear cover 400 by snap-fit coupling.

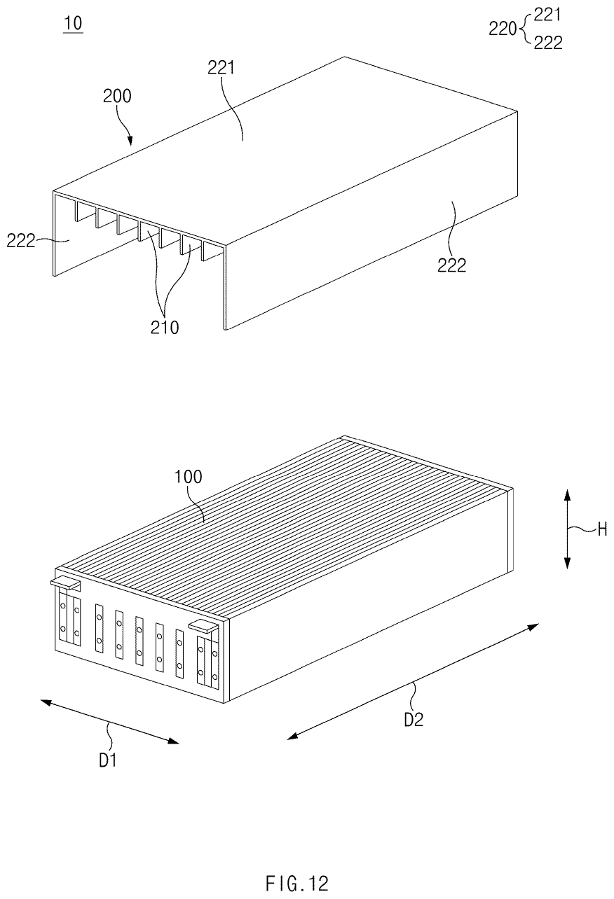

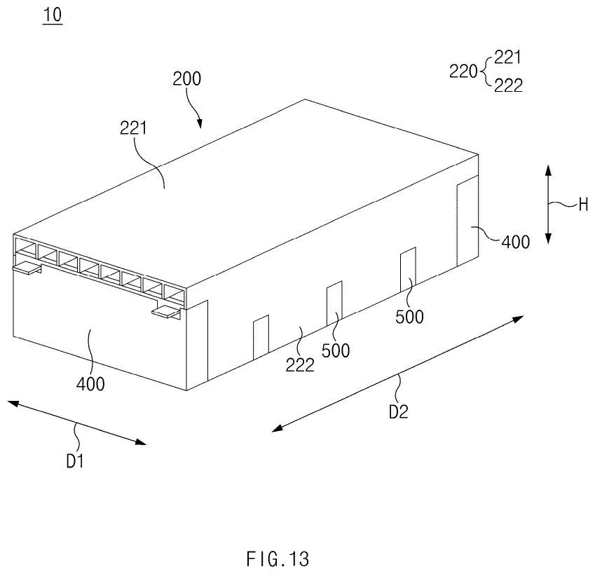

FIG. 12 is a perspective view illustrating a third example of the battery assembly according to the present disclosure, i.e., an exploded perspective view illustrating a state in which a cover part is spaced apart from another component of the battery assembly, and FIG. 13 is a perspective view illustrating a state in which the cover part of the battery assembly in FIG. 12 is coupled to another component of the battery assembly.

Similar to FIGS. 9 to 11, the battery assembly illustrated in FIGS. 12 and 13 may also be a battery module including a plurality of batteries. However, the battery assembly illustrated in FIGS. 12 and 13 may differ from the battery assembly illustrated in FIGS. 9 to 11 in that a component corresponding to the above-mentioned endplate is integrated with the cover part 200.

In some embodiments, and with reference to FIGS. 12 and 13, according to the third example of the present disclosure, the cover part 200 of the battery assembly 10 may include the partition wall regions 210 and further include a cover body 220 configured to define a body of the cover part 200. The partition wall region 210 may extend in the upward/downward direction H toward the battery group 100 from the cover body 220.

As illustrated in FIGS. 12 and 13, the cover body 220 may include a first cover section 221 provided to face the battery group 100 in the upward/downward direction H and having one side from which the partition wall regions 210 extend, and second cover sections 222 extending in the upward/downward direction H from two opposite sides of the first cover section 221 based on the first direction D1. The second cover section 222 may be a component that serves as the endplate 300 (see FIG. 9 and the like) provided in the battery module. Therefore, the second cover sections 222 may be tightly attached to two opposite surfaces of the battery group 100 based on the first direction D1 and press the battery group 100 in the first direction D1. Meanwhile, with reference to FIG. 13, the battery assembly 10 may further include clamp members 500 each having one end and the other end respectively fixed to the second cover sections 222 provided at the two opposite sides of the first cover section 221, the clamp member 500 including an extension section configured to connect the one end and the other end thereof. The extension section of the clamp member 500 may be spaced apart from the first cover section 221 in the upward/downward direction H. In some embodiments in instances in which the first cover section 221 is provided in the upper region of the battery assembly 10, the extension section of the clamp member 500 is provided to face the lower region of the battery assembly 10. In other embodiments, in instances in which the first cover section 221 is provided in the lower region of the battery assembly 10, the extension section of the clamp member 500 may be provided to face the upper region of the battery assembly 10.

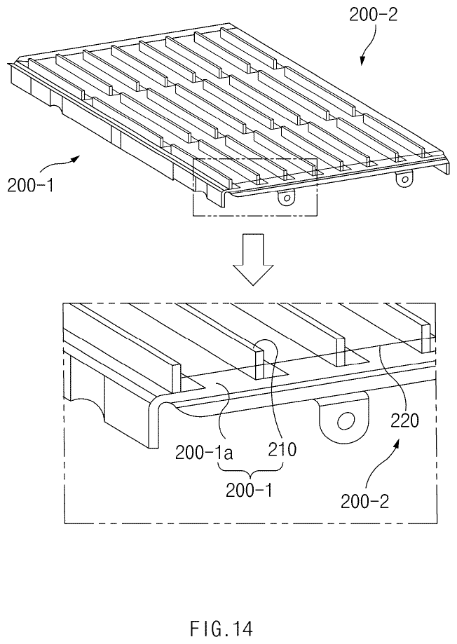

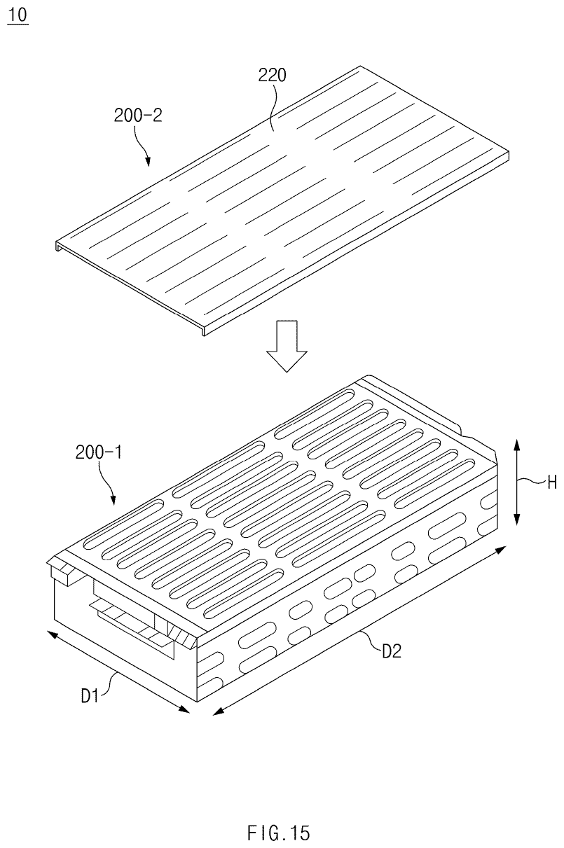

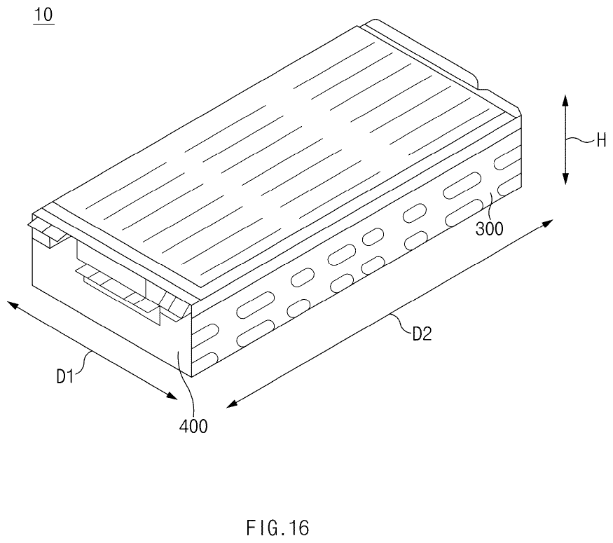

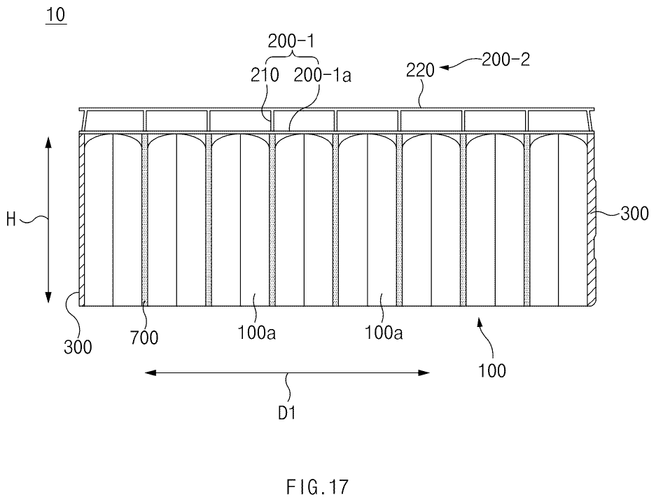

FIG. 14 is a perspective view illustrating a cover part of a fourth example of the battery assembly according to the present disclosure, and FIG. 15 is a perspective view illustrating a fourth example of the battery assembly according to the present disclosure (e.g., an exploded perspective view illustrating a state in which a cover part is spaced apart from another component of the battery assembly). FIG. 16 is a perspective view illustrating a state in which the cover part of the battery assembly in FIG. 15 is coupled to another component of the battery assembly, and FIG. 17 is a vertical cross-sectional view of FIG. 16.

Similar to FIGS. 9 to 13, the battery assembly illustrated in FIGS. 14 to 17 may also be a battery module including a plurality of batteries. However, the battery assembly illustrated in FIGS. 14 to 17 may differ from the battery assembly illustrated in FIGS. 9 to 11 and the battery assembly illustrated in FIGS. 12 and 13 in that a plurality of cover parts is provided.

According to the fourth example of the present disclosure, the cover part 200 may include the partition wall regions 210, and the cover body 220 configured to define a body of the cover part 200.

In some embodiments, and as illustrated in FIGS. 14 to 17, the cover part 200 may include a first cover part 200-1 provided to face the battery group 100 in the upward/downward direction H and having one side from which the partition wall regions 210 extend, and a second cover part 200-2 having the cover body 220. That is, according to the fourth example of the present disclosure, the partition wall region 210 and the cover body 220 may be provided as separate components.

The first cover part 200-1 may be configured to be closer to the battery group 100 than the second cover part 200-2 to the battery group 100. For example, as illustrated in FIGS. 14 to 17, in case that the cover part 200 is provided above the battery group 100, the first cover part 200-1 may be provided below the second cover part 200-2.

With continued reference to FIGS. 14 to 17, the first cover part 200-1 may include an extension region 200-1a extending in the first direction D1 from one end of the partition wall region 210 and provided to face the cover body 220 with the partition wall region 210 interposed therebetween. That is, according to the fourth example of the present disclosure, the extension region 200-1a, the partition wall region 210, and the cover body 220 may be sequentially provided in a direction away from the battery group 100. The extension region 200-1a may be provided to directly face the battery group 100. Therefore, in case that thermal runaway occurs in some of the batteries 100a in the battery group 100, heat or gas, which is caused by the thermal runaway, may reach the extension region 200-1a of the cover part 200 first. In this case, the extension region 200-1a may be in contact with, tightly attached to, or joined to a pad member 700 provided between the two batteries 100a provided adjacent to each other in the first direction D1 among the plurality of batteries 100a in the battery group 100. In this case, even though thermal runaway occurs in the battery 100a, heat or gas, which is caused by the thermal runaway, may not move to another adjacent battery 100a but may move along the extension region 200-1a and be introduced into a space defined by the partition wall region 210 and the cover body 220.

Meanwhile, the first cover part 200-1 may be provided integrally. Therefore, the partition wall region 210 and the extension region 200-1a may also be integrated. The partition wall region 210 may have a shape bent in the upward/downward direction H from one end of the extension region 200-1a based on the first direction D1. More specifically, the extension region 200-1a may be provided as a plurality of extension regions 200-1a provided in the first direction D1, and an empty space may be defined between the two extension regions 200-1a adjacent to each other in the first direction D1. In this case, the partition wall region 210 may be sized to fill the empty space between the two extension regions 200-1a when the partition wall region 210 is bent by about 90 degrees toward the extension region 200-1a. The empty space between the two extension regions 200-1a may serve as a flow path that allows heat or gas, which is produced in the battery 100a, to be introduced into the space defined by the partition wall region 210 and the second cover part 200-2.

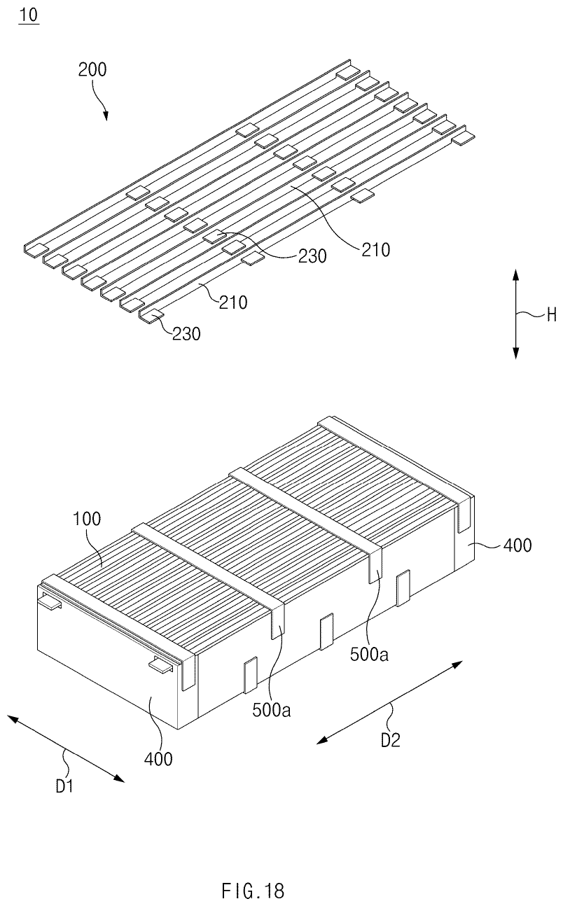

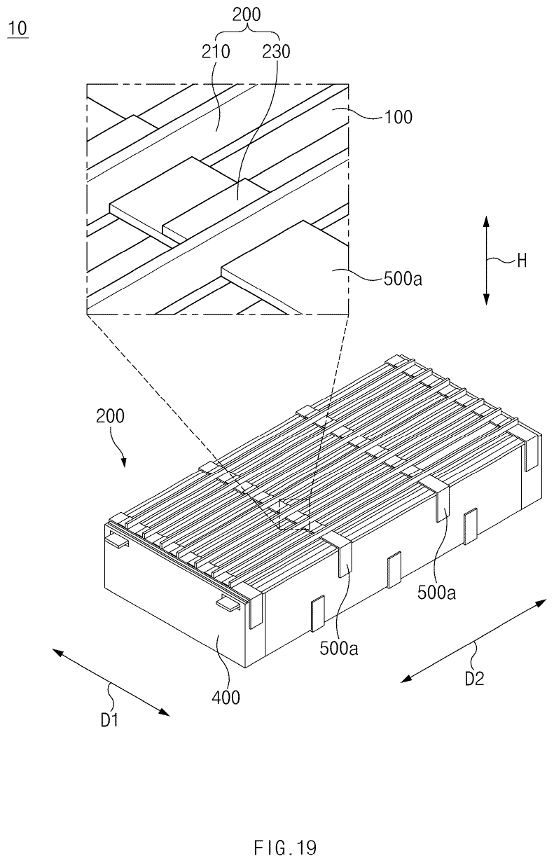

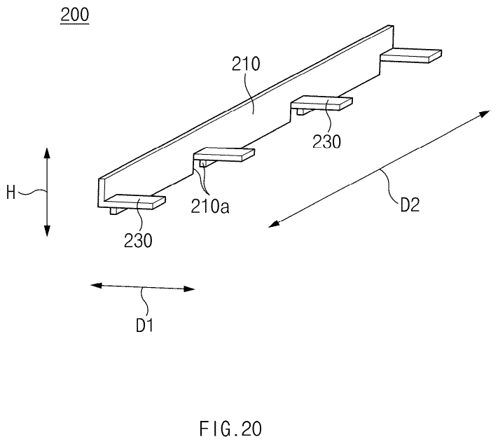

FIG. 18 is a perspective view illustrating a fifth example of the battery assembly according to the present disclosure, i.e., an exploded perspective view illustrating a state in which a cover part is spaced apart from another component of the battery assembly, and FIG. 19 is a perspective view illustrating a state in which the cover part of the battery assembly in FIG. 18 is coupled to another component of the battery assembly. FIG. 20 is a perspective view of the cover part applied to the battery assembly in FIGS. 18 and 19, and FIG. 21 is a perspective view of a modified example of the cover part applied to the battery assembly in FIGS. 18 and 19.

Similar to FIGS. 9 to 11, 12, 13, and 14 to 17, the battery assembly illustrated in FIGS. 18 to 21 may also be a battery module including a plurality of batteries. However, the battery assembly illustrated in FIGS. 18 to 21 may differ from the battery assemblies according to the first to fifth examples in that the cover part may be fixedly coupled to a clamp member to be described below.

According to the fifth example of the present disclosure, the battery assembly 10 may further include clamp members 500a each having one end and the other end respectively fixed to two opposite sides of the battery group 100 based on the first direction D1, the clamp member 500a having an extension section configured to connect the one end and the other end and provided to traverse an upper or lower surface of the battery group 100. In this case, the extension section of the clamp member 500a may be provided to traverse the upper or lower surface of the battery group 100 in a direction parallel to the first direction D1. FIGS. 18 and 19 illustrate an example in which the clamp members 500a include an upper clamp member provided to traverse the upper surface of the battery group 100, and a lower clamp member provided to traverse the lower surface of the battery group 100.

According to the fifth example of the present disclosure, the cover part 200 provided in the battery assembly 10 may be fixedly coupled to the region (i.e., the above-mentioned extension section) of the clamp member 500a that traverses the upper or lower surface of the battery group 100. More specifically, the cover part 200 may further include clamp coupling regions 230 extending in the first direction D1 from the partition wall regions 210 of the cover part, and the clamp coupling region 230 may be fixedly coupled to the clamp member 500a. That is, the clamp coupling region 230 may be provided in a region in which the partition wall region 210 of the cover part 200 and the clamp member 500a intersect each other. The clamp coupling region 230 and the clamp member 500a may be provided to face each other in the upward/downward direction. For example, the clamp coupling region 230 and the clamp member 500a may be fixedly coupled to each other by welding. Alternatively, the clamp coupling region 230 and the clamp member 500a may be fixedly coupled to each other by mechanical coupling using a bolt member or the like.

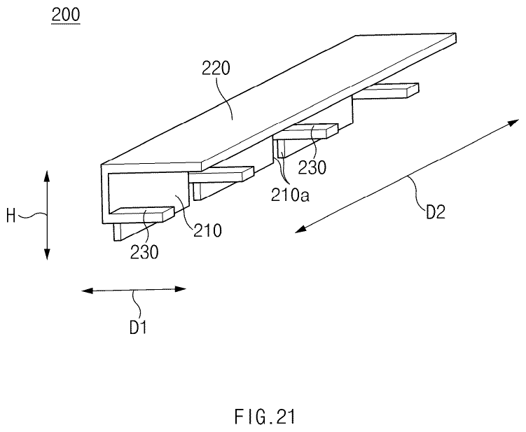

With reference to FIGS. 20 and 21, the cover part 200 in some embodiments does not include the cover body 220 (see FIG. 20) and in other embodiments does include the cover body 220 (see FIG. 21) configured to cover an upper surface of the cover part 200 and extending in the first direction D1 and the second direction D2.

With reference to FIGS. 18, 19, and 21, in embodiments in which the cover part 200 further includes the cover body 220 configured to define a body of the cover part, the partition wall region 210 may extend in the upward/downward direction H toward the battery group 100 from the cover body 220, and the clamp coupling region 230 may be provided between the cover body 220 and the battery group 100 in the upward/downward direction H. As illustrated in FIG. 20, in embodiments in which the cover part 200 does not include the cover body, the battery assembly may further include an additional configuration for covering an upper region of the cover part.

The clamp coupling region 230 may be provided as a plurality of clamp coupling regions 230. For example, the partition wall region 210 may have a shape extending in the second direction D2. In this case, the plurality of clamp coupling regions 230 may be spaced apart from one another in the second direction D2.

According to the fifth example of the present disclosure, the partition wall region 210, the cover body 220, and the clamp coupling region 230 of the cover part 200 may be integrated (e.g., integrally formed). In this case, the clamp coupling region 230 may have a shape made by cutting a partial region of the partition wall region 210 and then bending the partition wall region 210.

For example, and as illustrated in FIGS. 20 and 21, the partition wall region 210 may include a plurality of cut-out sections 210a spaced apart from one another in the second direction D2 and each having a shape recessed inward from one side end based on the upward/downward direction H. More specifically, the cut-out section 210a may be formed in a region of the end of the partition wall region 210 based on the upward/downward direction H that faces the battery group 100 (see FIGS. 18 and 19 and the like). FIGS. 20 and 21 illustrate that the cut-out section 210a has a shape recessed upward from a lower end of the partition wall region 210. It may be understood that the cut-out section 210a has an approximate ‘U’ cross-sectional shape.

The clamp coupling region 230 may include a shape bent in the first direction D1 from the other side end of the cut-out section 210a based on the upward/downward direction H. FIGS. 20 and 21 illustrate that a clamp coupling region 230 having a shape extending from an upper end of the cut-out section 210a and bent in the first direction D1. From the point of view of a manufacturing method, it may be understood that the clamp coupling regions 230 are manufactured by forming the plurality of cut-out sections 210a in a plate-shaped member having a shape extending in the second direction D2, and then bending, in the first direction D1, the regions in which the cut-out sections 210a are formed.

In embodiments in which that the clamp coupling region 230 has the above-mentioned shape, the clamp coupling region 230 may be positioned between an upper end and a lower end of the partition wall region 210. According to the fifth example of the present disclosure, at least a part of a portion of the partition wall region 210, which is provided to be closer to the battery group 100 than the clamp coupling region 230 to the battery group 100, may be inserted into a space between the two batteries 100a provided adjacent to the partition wall region 210 in the first direction D1. More specifically, at least a part of the partition wall region 210 may be tightly attached to a lateral surface of the battery provided adjacent to the partition wall region 210 in the first direction D1 among the batteries 100a in the battery group 100. In this case, it is possible to more effectively prevent thermal energy or gas, which is caused by thermal runaway in the battery 100a, from diffusing to the adjacent battery 100a.

As illustrated in FIG. 21, in embodiments in which the cover part 200 has the cover body 220 in the battery assembly according to the fifth example of the present disclosure, the cover body 220 may be configured to cover the entire regions of the clamp coupling regions 230 from above. For example, when the battery assembly or the cover part 200 is viewed from one side spaced apart from the battery assembly or the cover part 200 in the upward/downward direction H, the cover body 220 may be provided to overlap the entire regions of the clamp coupling regions 230. It may be understood that a length by which the cover body 220 extends in the first direction D1 from the partition wall region 210 is longer than a length by which the clamp coupling region 230 extends in the first direction D1 from the partition wall region 210.

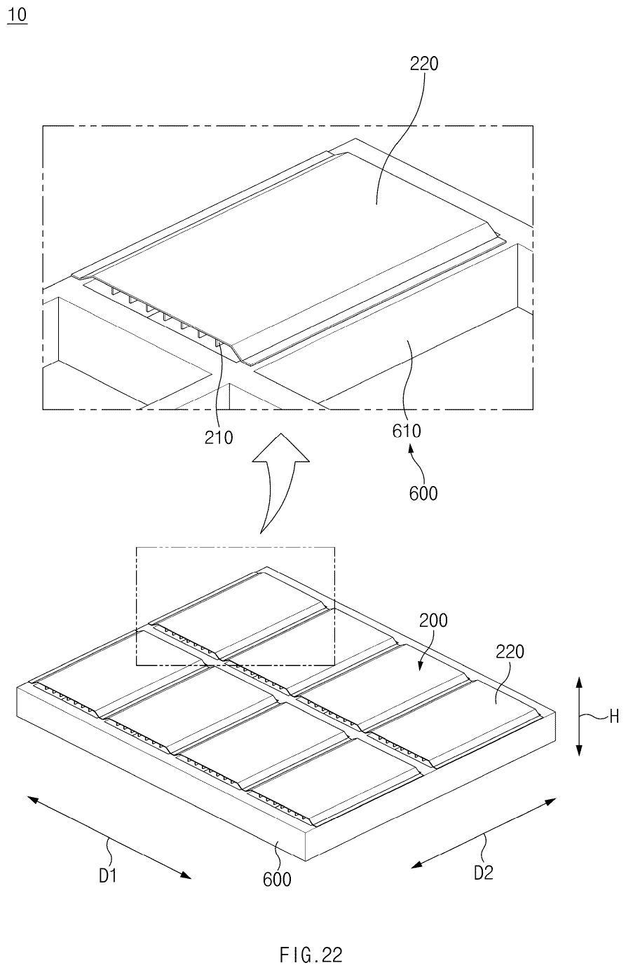

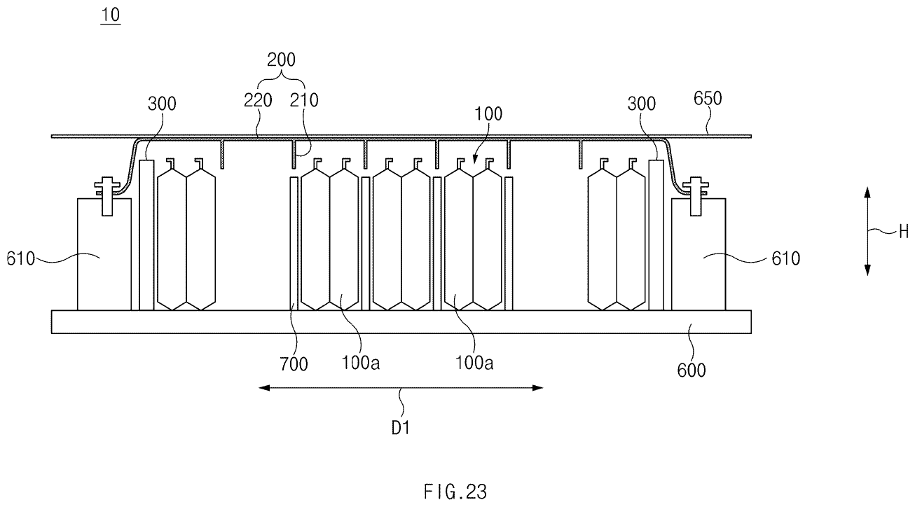

FIG. 22 is a perspective view illustrating a sixth example of the battery assembly according to the present disclosure, i.e., a view illustrating a structure for coupling a casing body part and a cover part of the battery assembly, and FIG. 23 is a vertical cross-sectional view of the sixth example of the battery assembly according to the present disclosure.

Unlike the battery assemblies according to the first to fifth examples of the present disclosure described above with reference to FIGS. 1 to 3 and 9 to 21, the battery assembly according to the sixth example of the present disclosure may be applied to a battery pack unit instead of the battery module.

In some embodiments, and with reference to FIGS. 22 and 23, the battery assembly 10 according to the sixth example of the present disclosure may also include the battery group 100, the cover part 200 including the partition wall regions 210 and the cover body 220, the endplates 300, and the pad members 700. The description of the battery group 100, the partition wall region 210, the cover body 220, the cover part 200, the endplate 300, and the pad member 700 may be replaced with the description of the first to fifth examples of the present disclosure.

According to the sixth example of the present disclosure, the battery assembly 10 may further include a casing body part 600 having a space for accommodating the battery group 100 and opened at one side based on the upward/downward direction H. FIGS. 22 and 23 illustrate that the casing body part 600 is opened upward. In this case, according to the sixth example of the present disclosure, the cover part 200 may be provided to cover the opened region of the casing body part 600.

As described above, the battery assembly 10 according to the sixth example of the present disclosure may be a battery pack. In this case, the casing body part 600 may accommodate a plurality of battery groups 100. The casing body part 600 may have a division configuration for separating spaces in which the plurality of battery groups 100 is accommodated. For example, the casing body part 600 may include a plurality of division regions 610 spaced apart from one another in the first direction D1 and configured to define therein the spaces in which the battery groups 100 are accommodated. In this case, according to the present disclosure, an end of the cover part 200 based on the first direction D1 may be fixedly coupled to different division regions 610. The division region 610 may be configured to define an outer surface provided to face the outside of the casing body part 600.

The sixth example of the present disclosure may further include a configuration for protecting the cover part 200 by covering the cover part 200 from the outside. For example, and as illustrated in FIGS. 22 and 23, according to the sixth example of the present disclosure, the battery assembly 10 may further include a covering part 650 provided to face the battery group 100 with the cover part 200 interposed therebetween and configured to cover the cover part 200. In case that the battery assembly 10 is a battery pack, the covering part 650 may be a cover of the battery pack. FIG. 23 illustrates that the cover part 200 is provided to cover an upper side of the casing body part 600, and the covering part 650 is provided to cover an upper side of the cover part 200.

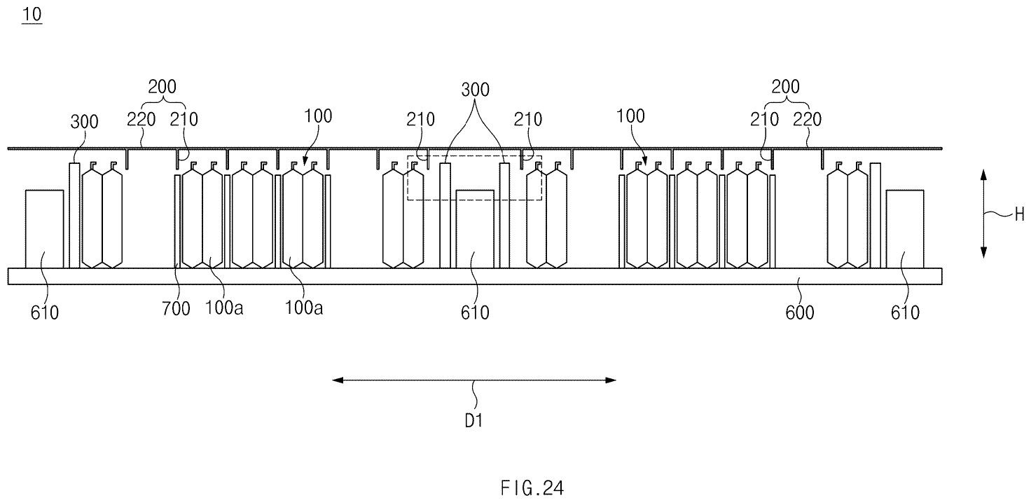

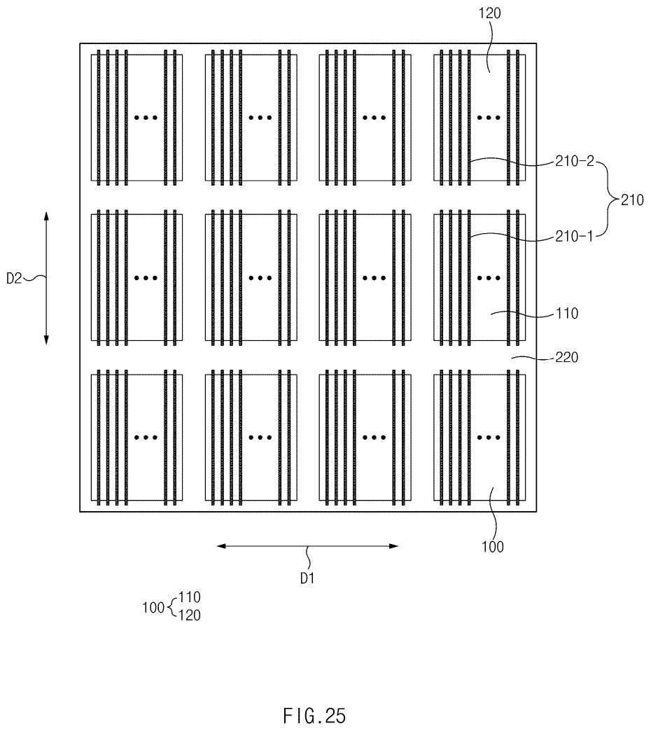

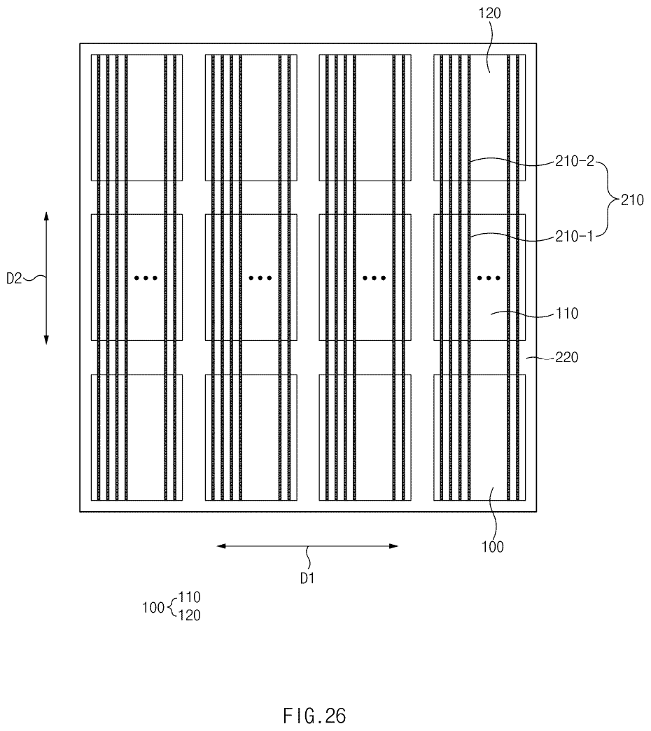

FIG. 24 is a vertical cross-sectional view illustrating a seventh example of the battery assembly according to the present disclosure, and FIG. 25 is an example of a top plan view of the battery assembly in FIG. 24. FIG. 26 is another example of a top plan view of the battery assembly in FIG. 24.

Like the sixth example of the present disclosure, the battery assembly according to the seventh example of the present disclosure may also be applied to the battery pack unit. However, the seventh example of the present disclosure may differ from the sixth example of the present disclosure in that the cover part 200 of the battery assembly also serves as the covering part 650. With regards to at least the seventh example, the description of the battery group 100, the partition wall region 210, the cover body 220, the cover part 200, the endplate 300, and the pad member 700 provided in the battery assembly may be replaced with the description of the first to fifth examples of the present disclosure.

With reference to FIGS. 24 to 26, the battery assembly 10 according to the seventh example of the present disclosure may further include the casing body part 600 having the space for accommodating the battery group 100 and opened at one side based on the upward/downward direction H. The cover part 200 may be provided to cover the opened region of the casing body part 600. According to the seventh example of the present disclosure, the battery group 100 may include a first battery group 110 and a second battery group 120 provided to face each other in the second direction D2.

In some embodiments, and as illustrated in FIG. 24, the plurality of partition wall regions 210 may be spaced apart from one another in the first direction D1. Some of the plurality of partition wall regions 210 may be provided between the two battery groups 100 adjacent to each other in the first direction D1. As described above, the partition wall regions 210, which may be provided between the two battery groups 100 adjacent to each other in the first direction D1, may serve to prevent thermal runaway, which occurs in one battery group 100, from affecting another adjacent battery group 100.

In some embodiments, and as illustrated in FIG. 24, the casing body part 600 may further include the plurality of division regions 610 spaced apart from one another in the first direction D1 and configured to define therein the spaces in which the battery groups 100 are accommodated. Some of the plurality of partition wall regions 210 may be provided between the division region 610 and the battery group 100 provided adjacent to the division region 610. More particularly, the partition wall regions 210 may be respectively provided at two opposite sides of the division region 610 based on the first direction D1. That is, some of the plurality of partition wall regions 210 may be provided i) between the division region 610 and the battery group 100 provided adjacent to the division region 610 at one side based on the first direction D1 and ii) between the division region 610 and the battery group 100 provided adjacent to the division region 610 at the other side based on the first direction D1 (see the dotted line region in FIG. 24).

Within the battery assembly 10 according to the seventh example of the present disclosure, the plurality of partition wall regions 210 may be provided to be spaced apart from one another in the second direction D2. For example, as illustrated in FIG. 25, the partition wall regions 210 may include a first partition wall region 210-1 provided to face the first battery group 110 in the upward/downward direction H, and a second partition wall region 210-2 spaced apart from the first partition wall region 210-1 in the second direction D2 and provided to face the second battery group 120 in the upward/downward direction H. It may be understood that the partition wall regions 210 are provided to at least face the plurality of battery groups 100 in the upward/downward direction H.

In contrast, in the battery assembly 10 according to the seventh example of the present disclosure, the partition wall regions 210 may be provided to correspond to the battery groups 100 in a one-to-one manner. For example, as illustrated in FIG. 26, the partition wall region 210 may be configured as a single member or include the single member provided to face i) the first battery group 110, ii) the second battery group 120, and iii) a space between the first battery group 110 and the second battery group 120 in the upward/downward direction H.

As described above, the partition wall region 210 may be configured to prevent thermal runaway, which occurs in the battery 100a in the battery group 100, from affecting another battery group 100. The partition wall region 210 may be exposed to a large impact because of an increase in pressure caused by gas generated by the thermal runaway. Therefore, in order to improve the durability of the partition wall region 210 against an external force, additional features related to the partition wall region 210 may be added. Hereinafter, a structure for improving the durability of the partition wall region 210 against an external force will be described.

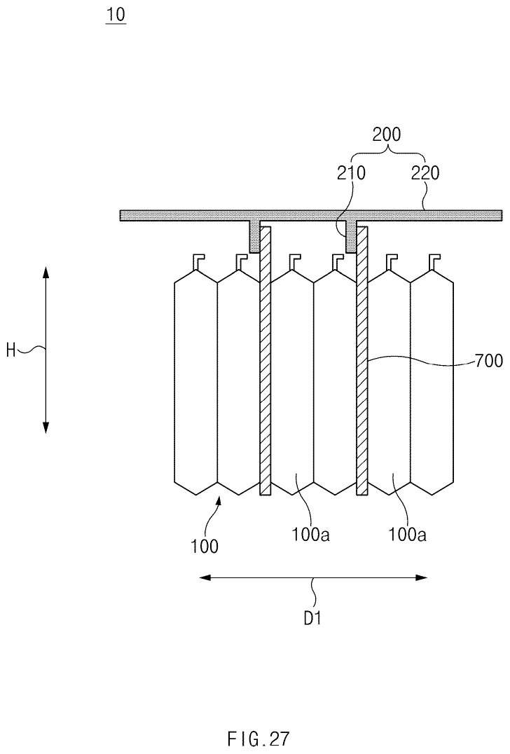

FIG. 27 is a vertical cross-sectional view illustrating a first example of a coupling relationship between the partition wall region and the pad member of the battery assembly according to the present disclosure.

According to the present disclosure, the battery group 100 may include the pad member 700 provided between the two batteries 100a adjacent to each other in the first direction D1 in the battery group 100 and tightly attached to the two batteries 100a. The description of the cover body, the endplate, the front and rear covers, and the like provided in the battery assembly 10 may be replaced with the description described above with reference to FIGS. 1 to 6.

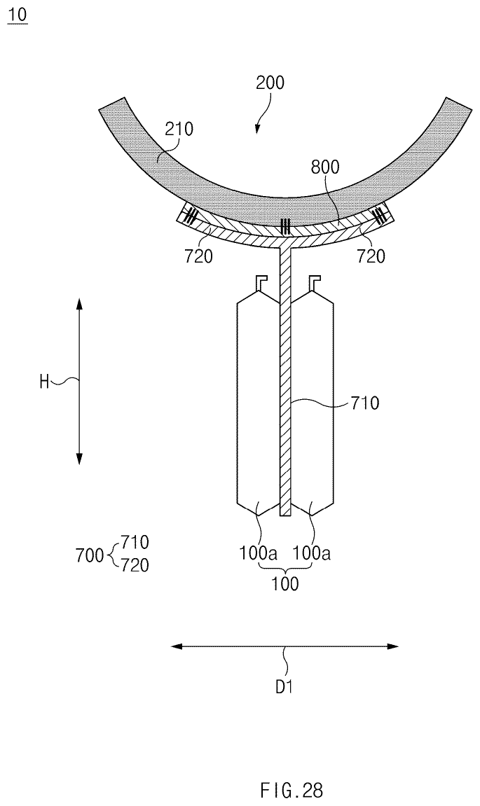

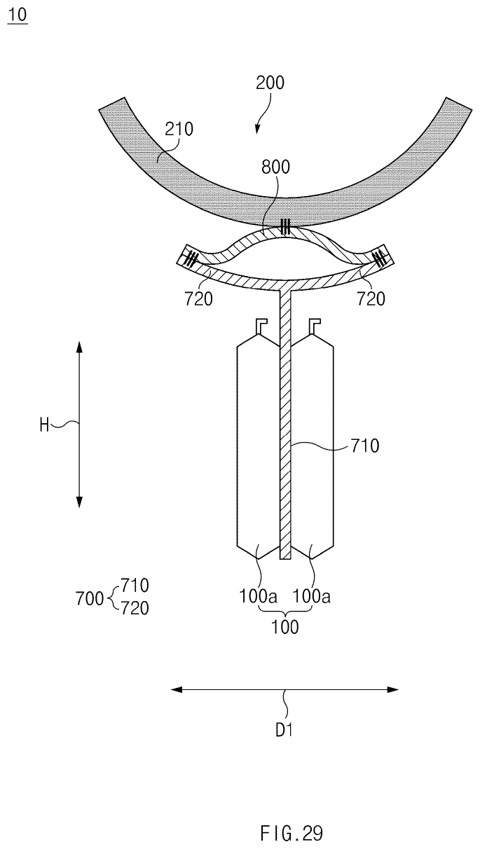

As illustrated in FIG. 27, the partition wall region 210 may be fixedly coupled to the pad member 700. In some embodiments, the pad member 700 may be a component that serves to apply a predetermined surface pressure to the battery 100a and/or to support the partition wall region 210. The pad member 700 may be configured to improve the durability of the partition wall region 210 against an external force. Various examples in which the partition wall region of the battery assembly according to the present disclosure is fixedly coupled to the pad member will be described in detail with reference to FIGS. 28 to 29.

FIG. 28 is a vertical cross-sectional view illustrating a second example of the coupling relationship between the partition wall region and the pad member of the battery assembly according to the present disclosure, and FIG. 29 is a vertical cross-sectional view illustrating a change in shapes of the partition wall region and the pad member in case that an internal pressure of a battery of the battery assembly in FIG. 28 increases.

With reference to FIGS. 28 and 29, the battery assembly 10 may further include a contact member 800 provided between the partition wall region 210 and the pad member 700. As illustrated in FIG. 28, one surface of the contact member 800 may be in contact with the partition wall region 210, and the other surface of the contact member 800 may be in contact with the pad member 700. The description of the cover body, the endplate, the front and rear covers, and the like provided in the battery assembly 10 may be replaced with the description described above with reference to FIGS. 1 to 6.

Furthermore, the contact member 800 may be joined to the partition wall region 210 and the pad member 700. In some embodiments, and as illustrated in FIGS. 28 and 29, one region of the contact member 800 may be joined to the partition wall region 210, and the other region of the contact member 800 may be joined to the pad member 700. A partial region of the region of the contact member 800, which is in contact with the partition wall region 210, may be joined to the partition wall region 210, and a partial region of the region of the contact member 800, which is in contact with the pad member 700, may be joined to the pad member 700.

For example, the pad member 700 may include an extension pad 710 extending in the upward/downward direction H and having at least a partial region provided between the two batteries 100a adjacent to each other in the first direction D1 in the battery group 100, and branch pads 720 branching off from an end of the extension pad 710 based on the upward/downward direction H toward two opposite sides. The extension pad 710 and the branch pad 720 may be integrated. As illustrated in FIG. 28, the pad member 700 may be understood as having an approximate ‘Y’ shape.

In this case, the contact member 800 may be joined to one side of each of the branch pads 720 branching toward two opposite sides. A region of the contact member 800, which faces a region in which the branch pads 720 branch off from the extension pad 710, may be joined to the partition wall region 210. The region of the contact member 800, which is joined to the branch pad 720, may be formed outward of, in the first direction D1, the region of the contact member 800 joined to the partition wall region 210.

In embodiments in which the partition wall region 210, the pad member 700, and the contact member 800 are joined as described above, the upper and lower surfaces of the contact member 800 are respectively tightly attached to the partition wall region 210 and the pad member 700 at ordinary times, as illustrated in FIG. 28. When the pressure in the space between the partition wall region 210 and the battery 100a increases as thermal runaway occurs in the battery 100a, the remaining region of the contact member 800, which excludes the region of the contact member 800 joined to the pad member 700, may move in the upward/downward direction H and become spaced apart from the pad member 700, and the partition wall region 210, together with the contact member 800, may also move in the upward/downward direction H and become spaced apart from the pad member 700. However, even in this case, the joint region formed between the partition wall region 210 and the contact member 800 may maintain the sealability between the two adjacent batteries 100a, which may more effectively prevent thermal runaway, which occurs in some of the batteries 100a, from affecting another battery 100a.

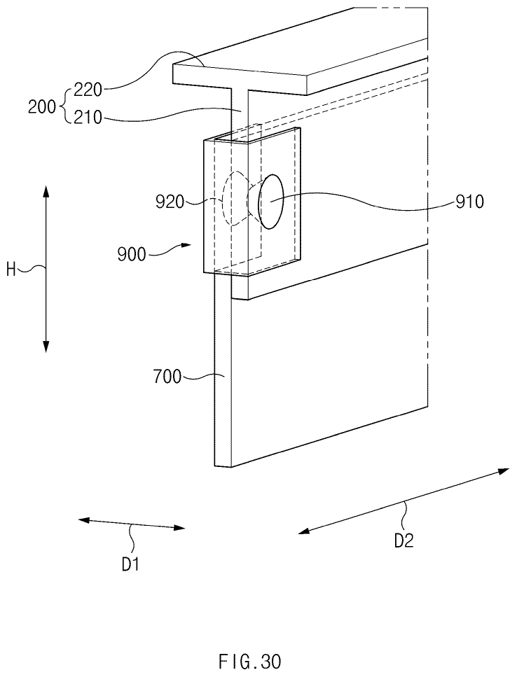

FIG. 30 is a perspective view illustrating a third example of the coupling relationship between the partition wall region and the pad member of the battery assembly according to the present disclosure.

With reference to FIG. 30, the battery assembly may further include a fixing member 900 having one side being in contact with the partition wall region 210, and the other side being in contact with the pad member 700. The description of the cover body, the endplate, the front and rear covers, and the like provided in the battery assembly 10 may be replaced with the description described above with reference to FIGS. 1 to 6.

A body of the fixing member 900 may have an approximate ‘U’ cross-sectional shape. In some embodiments, the fixing member 900 may include a first insertion region 910 extending from the region being in contact with the partition wall region 210 and configured to be inserted into the partition wall region 210, and a second insertion region 920 extending from the region being in contact with the pad member 700 and configured to be inserted into the pad member 700. The first insertion region 910 and the second insertion region 920 may be configured to allow the fixing member 900 to be fixed to the partition wall region 210 and the pad member 700, such that the partition wall region 210 and the pad member 700 may be fixedly coupled to each other.

Various examples of the battery assembly according to the present disclosure described with reference to the drawings are not intended to be applied exclusively. Various examples of the battery assembly according to the present disclosure may be applied simultaneously without contradicting each other.

For example, various examples related to the shapes of the partition wall regions described above with reference to FIGS. 4 to 8 may also be applied to the partition wall regions provided in the battery assembly configured as the battery module or battery pack described above with reference to FIGS. 1 to 3 and 9 to 26. In addition, various examples related to the partition wall region, the pad member, the bonding member, and the fixing member described above with reference to FIGS. 27 to 30 may be equally applied to the battery assembly configured as the battery module or battery pack described above with reference to FIGS. 1 to 3 and 9 to 26. In addition, i) the description of the shapes of the partition wall regions described above with reference to FIGS. 4 to 8 and ii) the description of various examples related to the partition wall region, the pad member, the bonding member, and the fixing member described above with reference to FIGS. 27 to 30 may, of course, be applied together to the battery assembly configured as the battery module or battery pack described above with reference to FIGS. 1 to 3 and 9 to 26.

The present disclosure has been described with reference to the limited embodiments and the drawings, but the present disclosure is not limited thereby. The present disclosure may be carried out in various forms by those skilled in the art, to which the present disclosure pertains, within the technical spirit of the present disclosure and the scope equivalent to the appended claims.

What is claimed is:

1. A battery assembly comprising:
a battery group comprising a plurality of batteries arranged in a first direction D1 intersecting an upward/downward direction H; and
a cover part provided at one side of the battery group based on the upward/downward direction H,
wherein the cover part comprises a partition wall region extending in the upward/downward direction H toward the battery group, and
wherein the partition wall region is provided in a region between two adjacent batteries of the plurality of batteries based on the first direction D1.

2. The battery assembly of claim 1, wherein the partition wall region at least partially overlaps, in the upward/downward direction H, the two adjacent batteries provided adjacent to two opposite sides of the partition wall region based on the first direction D1 among the plurality of batteries of the battery group.

3. The battery assembly of claim 1, wherein the cover part further comprises a cover body configured to define a body of the cover part,
wherein the partition wall region extends in the upward/downward direction H toward the battery group from the cover body, and
wherein the partition wall region is integrated with the cover body.

4. The battery assembly of claim 1, wherein the cover part further comprises a cover body configured to define a body of the cover part,
wherein the partition wall region extends in the upward/downward direction H toward the battery group from the cover body,
wherein the partition wall region and the cover body are provided as separate components, and
wherein the partition wall region comprises:
a coupling section fixedly coupled to the cover body; and
an extension section extending toward the battery group from the coupling section.

5. The battery assembly of claim 4, wherein the extension section extends toward the battery group from one end of the coupling section based on the first direction D1.

6. The battery assembly of claim 4, wherein the extension section extends toward the battery group from a region spaced apart from two opposite ends of the coupling section based on the first direction D1.

7. The battery assembly of claim 4, wherein the extension section comprises:
a first extension section extending toward the battery group from one side of the coupling section; and
a second extension section extending toward the battery group from the other side of the coupling section and provided to be spaced apart from the first extension section.

8. The battery assembly of claim 3, wherein the partition wall region has a shape recessed in the upward/downward direction H toward the battery group from the cover body.

9. The battery assembly of claim 1, further comprising:
endplates provided at two opposite sides of the battery group based on the first direction D1; and
front and rear covers provided at two opposite sides of the battery group based on a second direction D2 intersecting the first direction D1 and the upward/downward direction H,
wherein the cover part is fixedly coupled to the endplates or the front and rear covers.

10. The battery assembly of claim 9, wherein the cover part is fixedly coupled to the endplates or the front and rear covers by: i) welding, ii) bolting, or iii) snap-fit coupling.

11. The battery assembly of claim 1, wherein the cover part further comprises a cover body configured to define a body of the cover part,
wherein the partition wall region extends in the upward/downward direction H toward the battery group from the cover body, and
wherein the cover body comprises:
a first cover section provided to face the battery group in the upward/downward direction H and having one side from which the partition wall region extends; and
second cover sections extending in the upward/downward direction H from two opposite sides of the first cover section based on the first direction D1 and tightly attached to the battery group to press the battery group in the first direction D1.

12. The battery assembly of claim 11, further comprising:
a clamp member having one end and another end fixed to the second cover sections provided at the two opposite sides of the first cover section, the clamp member having an extension section configured to connect one end and the other end and spaced apart from the first cover section in the upward/downward direction H.

13. The battery assembly of claim 1, wherein the cover part further comprises a cover body configured to define a body of the cover part,
wherein the cover part comprises:
a first cover part provided to face the battery group in the upward/downward direction H and having one side from which the partition wall region extends; and
a second cover part having the cover body, and
wherein the first cover part further comprises an extension region extending in the first direction D1 from one end of the partition wall region and provided to face the cover body with the partition wall region interposed therebetween.

14. The battery assembly of claim 13, wherein the partition wall region has a shape bent in the upward/downward direction H from one end of the extension region based on the first direction D1.

15. The battery assembly of claim 1, further comprising:
a clamp member having one end and another end respectively fixed to two opposite sides of the battery group based on the first direction D1, the clamp member having an extension section configured to connect one end and the other end and provided to traverse an upper or lower surface of the battery group,
wherein the cover part is fixedly coupled to a region of the clamp member that traverses the upper or lower surface of the battery group.

16. The battery assembly of claim 15, wherein the cover part further comprises a clamp coupling region extending in the first direction D1 from the partition wall region, and
wherein the clamp coupling region is fixedly coupled to the clamp member.

17. The battery assembly of claim 16, wherein the cover part further comprises a cover body configured to define a body of the cover part,
wherein the partition wall region extends in the upward/downward direction H toward the battery group from the cover body, and
wherein the clamp coupling region is provided between the cover body and the battery group in the upward/downward direction H.

18. The battery assembly of claim 16, wherein the partition wall region extends in a second direction D2 intersecting the first direction D1 and the upward/downward direction H,
wherein the clamp coupling region is provided as a plurality of clamp coupling regions, and
wherein the plurality of clamp coupling regions is provided to be spaced apart from one another in the second direction D2.

19. The battery assembly of claim 18, wherein the partition wall region further comprises a plurality of cut-out sections spaced apart from one another in the second direction D2 and each having a shape recessed inward from one side end based on the upward/downward direction H, and
wherein the clamp coupling region includes a shape bent in the first direction D1 from the other side end of the cut-out section based on the upward/downward direction H.

20. The battery assembly of claim 15, wherein at least a part of the partition wall region is attached to a lateral surface of the battery provided adjacent to the partition wall region in the first direction D1 among the batteries in the battery group.
